(19) United States
(12) Patent Application Publication
(10) Pub. No.: US 2026/0270546 A1
(43) Pub. Date: Sep. 10, 2026

(54) IMAGING SYSTEM AND CONTROL METHOD THEREOF

(71) Applicant: ARASHI VISION INC., Shenzhen (CN)

(72) Inventors: Hongbin XIAO, Shenzhen (CN); Genyuan WANG, Shenzhen (CN); Yanbing DENG, Shenzhen (CN)

(73) Assignee: ARASHI VISION INC., Shenzhen (CN)

(21) Appl. No.: 19/661,567

(22) Filed: Apr. 28, 2026

Related U.S. Application Data
(63) Continuation of application No. PCT/CN2023/132390, filed on Nov. 17, 2023.

(51) Int. Cl. H04N 23/62; G06F 3/04842; H04N 5/92; H04N 23/63; H04N 23/667

(52) U.S. Cl. CPC H04N 23/62; G06F 3/04842; H04N 5/92; H04N 23/632; H04N 23/667

(57) ABSTRACT

In some aspects, the present disclosure provides a method for controlling an imaging system. A user operation of an interaction apparatus can be obtained while a capturing device is in a video recording state. A recorded video can be processed based on the user operation of the interaction apparatus. The recorded video may include a video segment recorded by the capturing device in a current video recording state.

### CROSS-REFERENCE TO RELATED APPLICATION

This application is a continuation of International Application No. PCT/CN 2023/132390, filed on Nov. 17, 2023, the content of which is hereby incorporated by reference in its entirety.

### BACKGROUND

The present disclosure relates to the field of capturing technology, and particularly to an imaging system and a control method thereof.

With the continuous development of imaging technology, capturing devices are being applied more and more widely.

Taking a sports camera as an example, a user can typically use a sports camera to capture videos of sports scenes. However, during the video recording process, the recorded video may contain all or part of segments that are blurred, invalid, or otherwise affect the video quality. To address this issue, it is common to process the video by finding it on the video playback page after the video recording is completed, which leads to the problem that the video processing method in related technology is overly cumbersome.

### SUMMARY

In view of the above, it is necessary to provide an imaging system and a control method thereof to address the above technical problems, enabling video processing during the video recording process and improving the efficiency of video processing.

In a first aspect, the present disclosure provides a control method for an imaging system, including:
obtaining a user operation of an interaction apparatus while the capturing device is in a video recording state; and
processing a recorded video based on the user operation of the interaction apparatus, the recorded video includes a video segment recorded by the capturing device in the current video recording state.

In one implementation, processing a recorded video based on the user operation of the interaction apparatus includes:
deleting at least one video frame from the recorded video based on the user operation of the interaction apparatus.

In one implementation, deleting at least one video frame from the recorded video based on the user operation of the interaction apparatus includes:
in response to the user performing a first operation on the interaction apparatus, deleting the recorded video.

In one implementation, after deleting at least one video frame from the recorded video, the control method for the imaging system further includes:
controlling the capturing device to exit the video recording state.

In one implementation, obtaining the user operation of the interaction apparatus while the capturing device is in a video recording state includes:
obtaining the user operation of a recording element of the interaction apparatus while the capturing device is in a video recording state.

In one implementation, processing a recorded video based on the user operation of the interaction apparatus includes:
in response to the user performing a first operation on the recording element of the interaction apparatus, deleting the recorded video; and
in response to the user performing a second operation on the recording element of the interaction apparatus, saving the recorded video, where the first operation is different from the second operation.

In one implementation, the first operation includes: triggering the recording element of the interaction apparatus for a first preset duration; and
the second operation includes: triggering the recording element of the interaction apparatus for a second preset duration, where the first preset duration is longer than the second preset duration.

In one implementation, the first operation includes: triggering the recording element, and re-triggering the recording element for a fourth preset duration within a third preset duration after the triggering of the recording element.

In one implementation, processing a recorded video based on the user operation of the interaction apparatus includes:
in response to the user performing a third operation on the interaction apparatus, obtaining a segment to be cut selected by the user from the recorded video; and
deleting the segment to be cut from the recorded video and obtaining a trimmed video.

In one implementation, in response to the user performing the third operation on the interaction apparatus, obtaining the segment to be cut selected by the user from the recorded video includes:
in response to the user performing a cut trigger operation on the interaction apparatus, displaying a display element corresponding to the recorded video; and
determining the segment to be cut based on a segment selection operation performed by the user on the display element.

In one implementation, deleting the segment to be cut from the recorded video and obtaining the trimmed video includes:
obtaining a first video segment before a start time of the segment to be cut from the recorded video;
obtaining a second video segment after an end time of the segment to be cut from the recorded video; and
splicing the first video segment and the second video segment to obtain the trimmed video.

In one implementation, the control method for the imaging system further includes:
in response to the user performing the third operation on the interaction apparatus, controlling the capturing device to continue recording a video to obtain a continued recording video; and
obtaining a supplementary recorded video based on the trimmed video and the continued recording video.

In one implementation, the control method for the imaging system further includes:
in response to the user performing the third operation on the interaction apparatus, if controlling the capturing device to be in a paused video recording state, then after obtaining the trimmed video, displaying a video recording operation pop-up window, where the video recording operation pop-up window includes at least one operation option;
receiving a target operation option selected by the user from the at least one operation option; and
performing an operation corresponding to the target operation option.

In one implementation, performing an operation corresponding to the target operation option includes:
if the target operation option is a continue recording option, controlling the capturing device to continue video recording;
if the target operation option is a stop recording option, terminating the video recording state of the capturing device and saving the trimmed video; and
if the target operation option is a delete video option, deleting the trimmed video.

In one implementation, processing a recorded video based on the user operation of the interaction apparatus includes:
obtaining a user operation of the interaction apparatus while the capturing device is in a video recording state; and
marking at least one video frame in the recorded video based on the user operation of the interaction apparatus, where the recorded video includes a video segment recorded by the capturing device in the current video recording state.

In one implementation, marking at least one video frame in the recorded video based on the user operation of the interaction apparatus includes:
in response to the user performing a mark trigger operation on the interaction apparatus, displaying a display element corresponding to the recorded video; and
performing a time mark on at least one video frame in the recorded video based on a time mark operation performed by the user on the display element.

In one implementation, the control method for the imaging system further includes:
in response to the capturing device ending the video recording state, in response to the user triggering a video segment insertion command for a complete video recorded, determining an insertion time mark from the time marks in the complete video based on a time carried in the video segment insertion command; and
inserting a video segment carried in the video segment insertion command into a position corresponding to the insertion time mark.

In one implementation, the control method for the imaging system further includes:
in response to the capturing device ending the video recording state, in response to the user triggering a video segment replacement command for a complete video recorded, determining a replacement time mark from the time marks in the complete video based on a time carried in the video segment replacement command; and
replacing a video segment in the complete video corresponding to the replacement time mark with a video segment carried in the video segment replacement command.

In one implementation, processing a recorded video based on the user operation of the interaction apparatus includes:
obtaining a target parameter based on the user operation of the interaction apparatus; and
processing the recorded video based on the target parameter to obtain a target video.

In one implementation, processing the recorded video based on the target parameter to obtain the target video includes:
controlling the capturing device to record a continued recording video; and
obtaining the target video based on the target parameter, the continued recording video, and the recorded video.

In one implementation, the target parameter includes an insertion position selected by the user from the recorded video, and obtaining the target video based on the target parameter, the continued recording video, and the recorded video includes:
inserting the continued recording video into the recorded video based on the insertion position to obtain the target video.

In one implementation, the method further includes:
deleting a video segment in the recorded video after the insertion position.

In one implementation, obtaining the target video based on the target parameter, the continued recording video, and the recorded video includes:
determining a target segment in the recorded video based on the target parameter; and
replacing the target segment in the recorded video with the continued recording video to obtain the target video.

In one implementation, the target parameter includes a starting position selected by the user from the recorded video and a continued recording video duration of the continued recording video; and determining a target segment in the recorded video based on the target parameter includes:
determining the target segment in the recorded video based on the starting position and the continued recording video duration, where the starting position and a starting position of the target segment are at the same position, and a duration of the target segment is the same as the continued recording video duration.

In one implementation, the target parameter includes a starting position selected by the user from the recorded video and a target duration; and determining a target segment in the recorded video based on the target parameter includes:
determining the target segment in the recorded video based on the starting position and the target duration, where the starting position and a starting position of the target segment are at the same position, and a duration of the target segment is the same as the target duration.

In one implementation, the target parameter includes a starting position and an ending position selected by the user from the recorded video; and determining a target segment in the recorded video based on the target parameter includes:
determining a video segment between the starting position and the ending position in the recorded video as the target segment.

In a second aspect, some implementations of the present disclosure further provide an imaging system, including an imaging device, a memory, and a processor, where the memory stores a computer program, and the processor is connected to the imaging device and implements the steps of any of the methods provided in the first aspect when executing the computer program.

In a third aspect, the present disclosure further provides a control apparatus for an imaging system, including:
a first operation acquisition module, used to obtain a user operation of the interaction apparatus while the capturing device is in a video recording state; and
a processing module, used to process a recorded video based on the user operation of the interaction apparatus, the recorded video includes a video segment recorded by the capturing device in the current video recording state.

In a fourth aspect, some implementations of the present disclosure provide a computer device, including a memory and a processor, the memory stores a computer program, and the processor implements the steps of any of the methods provided in the first aspect when executing the computer program.

In a fifth aspect, some implementations of the present disclosure provide a computer-readable storage medium, on which a computer program is stored, and when the computer program is executed by a processor, the steps of any of the methods provided in the first aspect are implemented.

In a sixth aspect, some implementations of the present disclosure further provide a computer program product, including a computer program, and when the computer program is executed by a processor, the steps of any of the methods provided in the first aspect are implemented.

In the above imaging system and control method thereof, while the capturing device is in a video recording state, a user operation of the interaction apparatus is obtained, and the recorded video is processed based on the user operation of the interaction apparatus. The recorded video includes a video segment recorded by the capturing device in the current video recording state. In this method, during the recording process of the capturing device, the interaction apparatus can be operated, and the capturing device processes the recorded video based on the interaction apparatus, enabling the user to quickly delete unwanted video files or select part of the recorded video, reducing the cumbersome steps of processing the video after the video recording is completed, and improving the efficiency and convenience of video processing. Furthermore, the video is processed during the video recording process, thereby avoiding the step of storing redundant video in the capturing device and improving the utilization of the memory space of the capturing device.

### BRIEF DESCRIPTION OF DRAWINGS

In order to more clearly illustrate the technical solutions in some implementations of the present disclosure or related technology, the drawings required for the description of some implementations or related technology are briefly introduced below. It is obvious that the drawings described below are only some implementations of the present disclosure, and those of ordinary skill in the art can obtain other drawings based on these drawings without creative effort.

FIG. 1 is a diagram showing an imaging system which provides an environment for implementing a control method, according to some implementations of the present disclosure.

FIG. 2 is a flowchart of a first control method for an imaging system, according to some implementations of the present disclosure.

FIG. 3 is a flowchart of a second control method for an imaging system, according to some implementations of the present disclosure.

FIG. 4 is a flowchart of a third control method for an imaging system, according to some implementations of the present disclosure.

FIG. 5 is a flowchart of a fourth control method for an imaging system, according to some implementations of the present disclosure.

FIG. 6 is a flowchart of a fifth control method for an imaging system, according to some implementations of the present disclosure.

FIG. 7 is a flowchart of a sixth control method for an imaging system, according to some implementations of the present disclosure.

FIG. 8 is a flowchart of a seventh control method for an imaging system, according to some implementations of the present disclosure.

FIG. 9 is a flowchart of an eighth control method for an imaging system, according to some implementations of the present disclosure.

FIG. 10 is a flowchart of a ninth control method for an imaging system, according to some implementations of the present disclosure.

FIG. 11 is a flowchart of a tenth control method for an imaging system, according to some implementations of the present disclosure.

FIG. 12 is a flowchart of an eleventh control method for an imaging system, according to some implementations of the present disclosure.

FIG. 13 is a flowchart of a twelfth control method for an imaging system, according to some implementations of the present disclosure.

FIG. 14 is a flowchart of a thirteenth control method for an imaging system, according to some implementations of the present disclosure.

FIG. 15 is a flowchart of a fourteenth control method for an imaging system, according to some implementations of the present disclosure.

FIG. 16 is a flowchart of a fifteenth control method for an imaging system, according to some implementations of the present disclosure.

FIG. 17 is a structural block diagram of a control apparatus for an imaging system, according to some implementations of the present disclosure.

FIG. 18 is an internal structural diagram of a computer device, according to some implementations of the present disclosure.

The present disclosure will be described with reference to the accompanying drawings.

### DETAILED DESCRIPTION

In order to make the objectives, technical solutions, and advantages of the present disclosure clearer, the following provides a further detailed description of the present disclosure in conjunction with the accompanying drawings and implementations. It should be understood that the specific implementations described herein are merely for explaining the present disclosure and are not intended to limit the present disclosure.

FIG. 1 is a diagram showing an imaging system that provides an environment for implementing a control method, according to some implementations of the present disclosure. The imaging system can include a capturing device, and may also include related accessories, such as a remote control. The capturing device includes a camera and a computer device coupled to the camera. The computer device may be built into the capturing device or may be connected externally to the capturing device; and the computer device may be a terminal. The capturing device may be a camera, a mobile phone or tablet with a camera, or other devices with capturing functions. For example, the capturing device may be a sports camera 101 as shown in FIG. 1, which includes a camera and a computer device coupled to the camera.

In related technology, when a user records a video using a capturing device, if the user does not want the video or a certain segment of the video during the recording process, it is necessary to delete the video or clip the corresponding segment on the video playback page of the capturing device after the video recording is completed, which is relatively cumbersome.

To address this issue and others, some implementations of the present disclosure provide a control method for an imaging system, enabling the user to process the already-recorded video while using the capturing device, without having to enter the video playback page to process the recorded video after the video recording is completed.

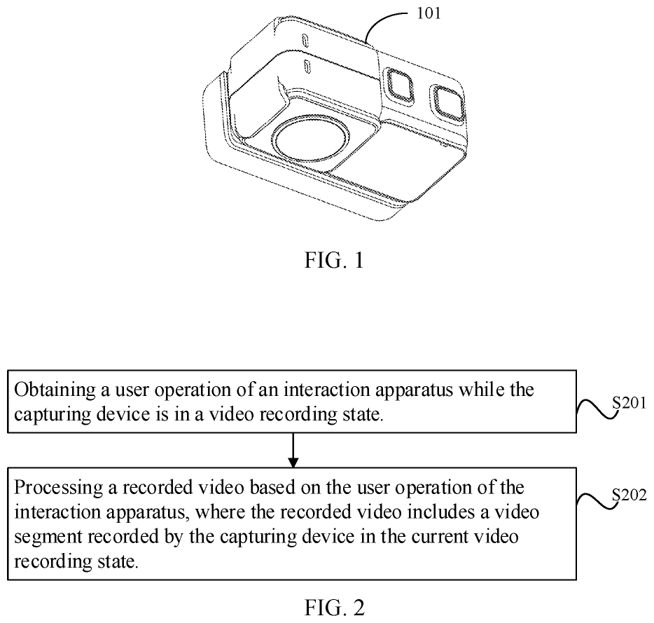

In an exemplary implementation, as shown in FIG. 2, a control method for an imaging system is provided, including the following operations.

S201: obtaining a user operation of an interaction apparatus while the capturing device is in a video recording state.

The capturing device in some implementations of the present disclosure not only includes a start-recording function and an end-recording function, but also includes a video deletion function in the video recording state, enabling deletion of the video or video segment during the video recording process.

The video deletion function can be set on the interaction apparatus corresponding to the capturing device. A user operates the interaction apparatus and the capturing device responds to the user operation of the interaction apparatus.

The interaction apparatus can be the recording interface of the capturing device, a button on the capturing device, or a remote control device corresponding to the capturing device, where the remote control device can be configured to control the functions of the capturing device.

The user can perform an operation on the recording interface to trigger the deletion operation of the recorded video of the capturing device; the interaction apparatus can also be a video deletion button on the capturing device, that is, the user clicks the video deletion button in the video recording state to trigger the video deletion operation; and the interaction apparatus can also be on the remote control device, where the user triggers the video deletion operation by clicking the remote control device.

S202: processing a recorded video based on the user operation of the interaction apparatus, where the recorded video includes a video segment recorded by the capturing device in the current video recording state.

The recorded video can be the video segment recorded by the capturing device in the current recording state before the user operates the interaction apparatus.

The capturing device can be configured to obtain the recorded video based on the user operation of the interaction apparatus and process the recorded video. The processing of the recorded video can be any operation that causes the video to change compared to before processing, such as deleting or editing the recorded video, etc. Editing can also include adding video segments to the recorded video, deleting video segments from the recorded video, and adding video effects, text, etc., to the recorded video.

In some implementations, the user operation of the interaction apparatus can include a deletion operation, an editing operation, a marking operation, etc. Different user operations of the interaction apparatus correspond to different ways of processing the recorded video.

For example, the computer device can preset a special effect trigger operation for adding special effects to the recorded video. When the user operation of the interaction apparatus is a special effect trigger operation, the computer device can add special effects to the recorded video according to the preset special effect mode; the special effect mode can include the specific content and specific method of addition.

In some implementations, when the user operation of the interaction apparatus is a deletion operation, the computer device can directly delete the recorded video, thereby reducing the generation of unwanted footage. Compared to user's deleting in the album page after recording is completed, this greatly simplifies the operation.

The control method for an imaging system provided in some implementations of the present disclosure, while the capturing device is in a video recording state, obtains a user operation of the interaction apparatus, and processes the recorded video based on the user operation of the interaction apparatus; and the recorded video includes a video segment recorded by the capturing device in the current video recording state. In this method, during the recording process of the capturing device, the user can operate the interaction apparatus, and the capturing device processes the recorded video based on the interaction apparatus, enabling the user to quickly delete unwanted video files or select certain segments of the recorded video, reducing the cumbersome steps of processing the video after recording is completed, and improving the efficiency and convenience of video processing. Furthermore, processing the video during the recording process avoids the step of storing unwanted segments (segments the user does not want) in the capturing device, improving the utilization of the memory space of the capturing device.

Processing the recorded video includes deleting at least one video frame from the recorded video. In an exemplary implementation, processing the recorded video based on the user operation of the interaction apparatus includes: deleting at least one video frame from the recorded video based on the user operation of the interaction apparatus.

The capturing device can delete at least one video frame from the recorded video based on the user operation of the interaction apparatus.

The capturing device can preset a specific deletion method, such as deleting all recorded video or deleting a certain segment of the recorded video. After the user operates the interaction apparatus, the capturing device can automatically delete at least one video frame from the recorded video according to the preset deletion method based on the user operation of the interaction apparatus. In some implementations, after deleting at least one video frame from the recorded video, the computer device can also control the capturing device to exit the video recording state.

In the contexts of the present disclosure, one video frame may be used to refer to a single still image within the recorded video. In contrast, one video segment may include a continuous sequence of multiple video frames, typically corresponding to a defined time interval within the recorded video.

In this way, the user performing the corresponding operation on the interaction apparatus is equivalent to the user wanting to cancel the current video being recorded by the capturing device and end the current recording, without saving the video recorded by the capturing device this time.

In the control method for an imaging system of the present disclosure, at least one video frame is deleted from the recorded video based on the user operation of the interaction apparatus. In this method, during the recording process of the capturing device, the user can operate the interaction apparatus of the capturing device, so that the capturing device can quickly delete the recorded video or part of the recorded video based on the user operation of the interaction apparatus, reducing the cumbersome steps of deleting the video after recording is completed, and improving the efficiency and convenience of video processing. Furthermore, during the video recording process, the user's unwanted video files are deleted, thereby avoiding the step of storing redundant video in the capturing device and improving the utilization of the memory space of the capturing device.

In an exemplary implementation, deleting at least one video frame from the recorded video based on the user operation of the interaction apparatus includes: in response to the user performing a first operation on the interaction apparatus, deleting the recorded video.

When the user performs the first operation on the interaction apparatus, the computer device can delete the recorded video; and in one implementation, after deleting the recorded video, the computer device can control the capturing device to exit the video recording state.

In this way, the user performing the first operation on the interaction apparatus indicates that the user wants to cancel the current video being recorded by the capturing device and end the current recording, without saving the video recorded by the capturing device this time.

Taking the shutter button of the capturing device as an example of the interaction apparatus, the way for the user to perform the first operation on the interaction apparatus can be that the user continuously triggers the shutter button for a preset duration, indicating that the user performs the first operation on the interaction apparatus. For example, the user presses and holds the shutter button for 1 second, deletes the recorded video, and controls the capturing device to exit the current video recording state.

In the control method for an imaging system of the present disclosure, in response to the user performing the first operation on the interaction apparatus, the recorded video is deleted. In this method, by the user performing the first operation on the interaction apparatus, the recorded video is deleted, so that the user can delete the video being recorded in the recording state of the capturing device, improving the speed and convenience of deleting the video.

In one implementation, the first operation can include: a deletion trigger operation and a confirmation operation for the deletion trigger operation.

The first operation includes a deletion trigger operation and a corresponding confirmation operation for the deletion trigger operation. In some implementations, the user performing the first operation on the interaction apparatus includes: the user performing the deletion trigger operation and the confirmation operation on the interaction apparatus.

For example, continuing with the shutter button of the capturing device as the interaction apparatus, when the user presses and holds the shutter button for a preset duration, it is determined that the user performs the deletion trigger operation. After the computer responds to the deletion trigger operation performed by the user, it confirms with the user whether to perform the deletion trigger operation. The user can continue to operate the interaction apparatus to perform the confirmation operation for the deletion trigger operation. For example, when the user presses and holds the shutter button for 1 second, it is determined that the user performs the deletion trigger operation. If the user continues to press and hold the shutter button for 2 seconds, it is determined that the user performs the confirmation operation for the deletion trigger operation and deletes the video. If the user does not continue to press and hold the shutter button for 2 seconds, the recording continues.

In some implementations, during the confirmation operation for the deletion trigger operation, the screen can display “cancelling recording,” or the motor inside the capturing device can vibrate to remind the user that the recording is about to be cancelled. At this time, if the user cancels the confirmation operation for the deletion trigger operation, the video recording continues.

In some implementations, the confirmation operation for the deletion trigger operation can also be performed by the user confirming on a prompt pop-up window displayed on the interaction apparatus.

In some implementations, after the computer device responds to the deletion trigger operation performed by the user, the computer device controls the screen of the capturing device to pop up a prompt window, displaying options for confirming or not confirming the deletion trigger operation.

For example, after the user presses and holds the shutter button for 1 second, the screen of the capturing device displays options corresponding to the deletion trigger operation, such as “cancel recording function option” and “trimmed video function option.” After the user selects the cancel recording function option, the screen of the capturing device pops up a prompt window, which includes a yes-option and a no-option, further allowing the user to confirm whether to confirm the deletion trigger operation.

If the user selects the yes-option in the prompt window, the video recording state of the capturing device can be terminated and the recorded video can be deleted; and the video will not be saved in the memory card of the capturing device.

If the user selects the no-option in the prompt window, the prompt window disappears, and the computer device controls the capturing device to continue the video recording function, that is, to continue recording the video.

In the control method for an imaging system of the present disclosure, the first operation includes: a deletion trigger operation and a confirmation operation for the deletion trigger operation. By the user performing the deletion trigger operation and the confirmation operation for the deletion trigger operation, the recorded video of the capturing device is deleted, so that the user can delete the video during the video recording process, and it will not be saved in the memory of the capturing device, improving the speed and intelligence of deleting the video.

In one implementation, obtaining the user operation of the interaction apparatus while the capturing device is in a video recording state includes: obtaining the user operation of a recording element of the interaction apparatus while the capturing device is in a video recording state.

While the capturing device is in a video recording state, the user operates the interaction apparatus to perform the deletion operation of the recorded video of the capturing device, which can be an operation on the recording element of the interaction apparatus, where the recording element can be an interactive area on the interaction apparatus for user interaction.

The term “recording element” of the interaction apparatus can refer to a touchable control displayed on the recording interface of the capturing device, where the touchable control includes a control element, which can be configured to control the video recording state of the capturing device and the deletion control of the recorded video. The recording element of the interaction apparatus can also be a physical button on the capturing device, and the user can perform operations on the button to realize functions such as deleting the recorded video. The button can be the shutter button of the capturing device.

The user can perform the first operation on the recording element of the interaction apparatus to realize the deletion of the recorded video, and after deleting the recorded video, control the capturing device to exit the video recording state.

In the control method for an imaging system of the present disclosure, obtaining the user operation of the recording element of the interaction apparatus while the capturing device is in a video recording state is provided. By the user operating the recording element of the interaction apparatus, at least one video frame in the recorded video recorded by the capturing device in the current recording state can be deleted, improving the simplicity of user operation and thus improving the convenience of video deletion.

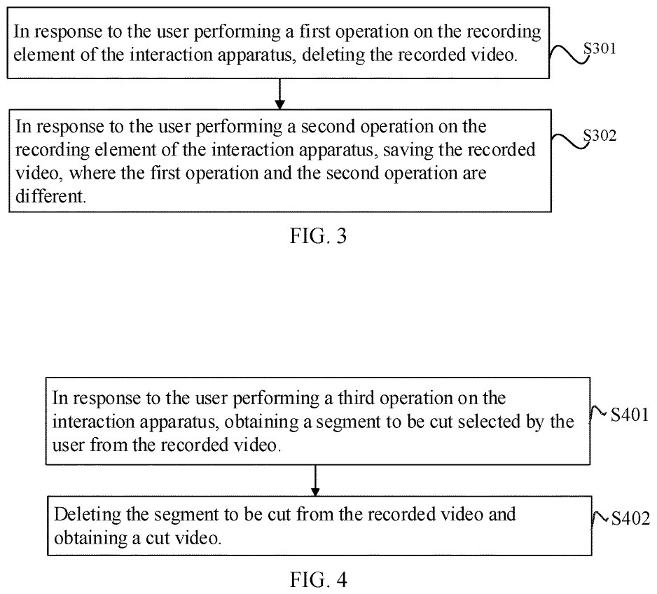

In an exemplary implementation, as shown in FIG. 3, processing a recorded video based on the user operation of the interaction apparatus includes:
S301: in response to the user performing a first operation on the recording element of the interaction apparatus, deleting the recorded video.

The first operation includes: triggering the recording element of the interaction apparatus for a first preset duration.

Taking the shutter button as the recording element of the interaction apparatus as an example, the first operation can be pressing and holding the shutter button for a first preset duration while the capturing device is in a recording state. When the user presses and holds the shutter button for the first preset duration while the capturing device is in a recording state, the computer device responds to the user operation of pressing and holding the shutter button for the first preset duration, deletes the recorded video of the capturing device, and can control the capturing device to exit the video recording state; the first preset duration can be 2 seconds.

During the user's triggering of the shutter button for the first preset duration, the display can also show the progress of the cancel recording loading circle being completed and vibrate.

In some implementations, the first preset duration is 1 second. While the capturing device is in a recording state, the user can press and hold the shutter button for 1 second (the first operation) to realize the deletion trigger operation. The screen of the capturing device can display “cancel recording function option” and “trimmed video function option.” The user clicks the “cancel recording function option” (the first operation), and the screen of the capturing device pops up a prompt window, displaying the option of whether to cancel recording. The user selects the yes-option (the first operation) in the prompt window, and the computer device deletes the recorded video in the capturing device.

In some implementations, the condition for the prompt window to pop up when the user continues to press and hold the shutter button for 2 seconds can also include: the progress of the loading circle of the shutter button is completed and vibrates. That is, after the user continues to press and hold the shutter button for 2 seconds and the progress of the loading circle of the shutter button is completed and vibrates, the screen of the capturing device pops up a prompt window.

In some implementations, the first preset duration can include a first target duration and a second target duration. The first target duration is 1 second, and the second target duration is 2 seconds. In response to the user performing the first operation on the recording element of the interaction apparatus, deleting the recorded video can also be: while the capturing device is in a recording state, the user can press and hold the shutter button for 1 second (the first target duration) to realize the deletion trigger operation. At this time, the screen of the capturing device can display a “cancel recording progress bar” with a duration of 2 seconds. The user continues to press and hold the shutter button for 2 seconds (the second target duration is 2 seconds), and the computer device deletes the recorded video in the capturing device.

It should be noted that the specific value of the first preset duration in some implementations of the present disclosure is not limited and can be determined according to actual conditions in practical applications.

In some implementations, while deleting the recorded video, the capturing device can be controlled to exit the video recording state and end the current recording; or the capturing device can be controlled to continue recording video.

S302: in response to the user performing a second operation on the recording element of the interaction apparatus, saving the recorded video, where the first operation and the second operation are different.

The second operation includes: triggering the recording element of the interaction apparatus for a second preset duration, where the first preset duration is longer than the second preset duration. In response to the user triggering the recording element of the interaction apparatus for the second preset duration, the recorded video is saved.

The first preset duration can be 0.5 seconds. Taking the shutter button as the recording element as an example, while the capturing device is in a recording state, the user presses and holds the shutter button for 0.5 seconds, and the computer device controls the capturing device to exit the recording state and save the recorded video.

In some implementations, taking the shutter button as the recording element of the interaction apparatus as an example, the second operation can also be clicking the shutter button while the capturing device is in a recording state.

While the capturing device is in a recording state, the user clicks the shutter button, and the computer device responds to the user operation of clicking the shutter button to save the recorded video of the capturing device.

In one implementation, while saving the recorded video, the capturing device can also be controlled to exit the video recording state and end the current recording.

While the capturing device is in a video recording state, if it is detected that the user triggers the recording element of the interaction apparatus for the first preset duration, the recorded video is saved; if it is detected that the user triggers the recording element of the interaction apparatus for the second preset duration, the recorded video is deleted; and the second preset duration is longer than the first preset duration. In this way, different video processing methods for the recorded video are realized through different trigger operations of the user on the recording element of the interaction apparatus, so that the user can trigger the operation of a single element according to actual needs, thereby simplifying the selection of video processing.

In the control method for an imaging system of the present disclosure, in response to the user performing the first operation on the recording element of the interaction apparatus, the recorded video is deleted; in response to the user performing the second operation on the recording element of the interaction apparatus, the recorded video is saved; and the first operation and the second operation are different. In this method, the first operation and the second operation are different, and the functions realized by the first operation and the second operation are also different, so that the user can perform the corresponding operation according to actual needs to realize different video processing functions, thereby improving the intelligent selection of video processing.

In one implementation, the first operation can also include: triggering the recording element, and re-triggering the recording element for a fourth preset duration within a third preset duration after the triggering of the recording element.

Continuing with the shutter button as the recording element as an example, if the third preset duration is 1 second and the fourth preset duration is 2 seconds, if the user clicks the shutter button and then, within 1 second, presses and holds the shutter button for 2 seconds, the recorded video is deleted; and if the user does not press and hold the shutter button for 2 seconds within 1 second after the user's clicking the shutter button, the capturing device can be controlled to stop recording.

It should be noted that during the user's triggering of the recording element of the interaction apparatus for the fourth preset duration, the progress of the loading circle of the shutter button is completed and the apparatus vibrates.

In some implementations of the present disclosure, the first operation can also include: triggering the recording element, and re-triggering the recording element for a fourth preset duration within a third preset duration after the triggering of the recording element. In this method, in the case of triggering the recording element and re-triggering the recording element for a fourth preset duration within a third preset duration after the triggering of the recording element, the recorded video is deleted. The deletion of the recorded video is realized through two operations, avoiding accidental deletion of the recorded video due to accidental touch of the recording element.

In an exemplary implementation, as shown in FIG. 4, processing a recorded video based on the user operation of the interaction apparatus includes the following operations.

S401: in response to the user performing a third operation on the interaction apparatus, obtaining a segment to be cut selected by the user from the recorded video.

The third operation can be a cut trigger operation. In response to the user performing a cut trigger operation on the recording element of the interaction apparatus, a segment to be cut selected by the user from the recorded video is obtained.

The cut trigger operation can be a preset operation. For example, the way for the user to perform the cut trigger operation on the interaction apparatus can be that the user continuously triggers the recording element of the interaction apparatus for a preset duration.

In some implementations, the way for the user to perform the cut trigger operation on the interaction apparatus can also be: while the capturing device is in a recording state, the user presses and holds the recording element for 1 second to realize the cut trigger operation. At this time, the screen of the capturing device can display “cancel recording function option” and “trimmed video function option” and the user clicks the “trimmed video function option.” After the user clicks the “trimmed video function option,” a segment to be cut selected by the user from the recorded video is obtained; and the segment to be cut can be a video segment that the user does not want.

In one implementation, as shown in FIG. 5, in response to the user performing the third operation on the interaction apparatus, obtaining a segment to be cut selected by the user from the recorded video includes the following operations.

S501: in response to the user performing a cut trigger operation on the interaction apparatus, displaying a display element corresponding to the recorded video.

In response to the user performing a cut trigger operation on the interaction apparatus, that is, when the user selects to cut the video, the computer device can obtain the recorded video collected by the capturing device before the cut trigger operation is performed and display the recorded video on the screen of the capturing device, so that the user can cut the recorded video.

The display element corresponding to the recorded video can be a progress bar. Therefore, the computer device can display the recorded video and the corresponding progress bar on the screen of the capturing device.

S502: determining the segment to be cut based on a segment selection operation performed by the user on the display element.

The user can perform a segment selection operation on the display element of the recorded video, and the video segment corresponding to the segment selection operation is determined as the segment to be cut.

For example, in the interface of the trimmed video function option, there is also a cut box and a button for confirming the cut. The cut box corresponds to the length of the video segment to be cut. The user can adjust the cut box according to the cutting needs, making the cut box larger or smaller. For example, the display element of the recorded video shows that the recorded video is 0 -10 seconds. The user wants to cut the video segment from 5 to 8 seconds, and thus the user can adjust the cut box and move the cut box to the video segment from 5 to 8 seconds according to the display element of the recorded video, and then click the button to confirm the cut, thereby sending the information of the segment to be cut from 5 to 8 seconds to the computer device of the capturing device, so as to obtain the segment to be cut selected by the user from the recorded video.

In some implementations, if the segment to be cut that the user needs to cut is the video segment from the previous moment to the current moment, the user can drag the progress bar in the recorded video to the previous moment, and then take the video segment between the previous moment and the current moment as the segment to be cut and send it to the computer device.

It should be noted that the segment to be cut is the video segment that the user wants to delete from the recorded video. The segment to be cut can be multiple video segments, that is, the user can select multiple segments to be cut in the recorded video. For example, the recorded video is 0 -10 seconds, and the segments to be cut can be the video segments from 2-5 seconds and 8-10 seconds.

S402: deleting the segment to be cut from the recorded video and obtaining a trimmed video.

The segment to be cut is deleted from the recorded video, and the remaining segments in the recorded video are spliced to obtain the trimmed video of the recorded video.

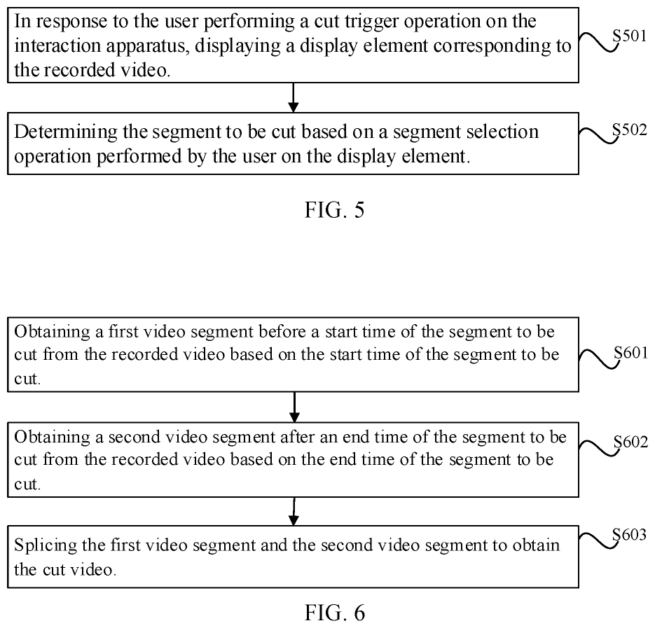

Taking the case where the recorded video includes one segment to be cut as an example, in an exemplary implementation, as shown in FIG. 6, deleting the segment to be cut from the recorded video and obtaining a trimmed video includes the following operations.

S601: obtaining a first video segment before a start time of the segment to be cut from the recorded video based on the start time of the segment to be cut.

S602: obtaining a second video segment after an end time of the segment to be cut from the recorded video based on the end time of the segment to be cut.

S603: splicing the first video segment and the second video segment to obtain the trimmed video.

The start time and end time of the segment to be cut are obtained, and based on the start time of the segment to be cut, the first video segment collected before the start time is obtained from the recorded video, and based on the end time of the segment to be cut, the second video segment collected after the end time is obtained from the recorded video. Then, the end time of the first video segment and the start time of the second video segment are spliced to obtain the trimmed video of the recorded video, where the trimmed video includes the first video segment and the second video segment.

Continuing with the example where the recorded video is 0 -10 seconds, if the segment to be cut is 5-8 seconds, the first video segment is 0-5 seconds, and the second video segment is 8-10 seconds. Then, the video segments of 0-5 seconds and 8-10 seconds are spliced together to obtain the trimmed video of the recorded video.

It should be noted that if the segment to be cut in the recorded video includes multiple segments, the same principle as above is used to delete the segment to be cut from the recorded video, and the remaining segments are spliced in sequence according to the recording time.

In the control method for an imaging system of the present disclosure, a first video segment before a start time of the segment to be cut is obtained from the recorded video based on the start time of the segment to be cut, and a second video segment after an end time of the segment to be cut is obtained from the recorded video based on the end time of the segment to be cut. Then, the first video segment and the second video segment are spliced to obtain the trimmed video. The user can selectively cut specific parts of the video as needed, remove unnecessary content or extract important segments, and by cutting the video, remove lengthy or irrelevant content, improving the viewing experience and the effectiveness of information delivery.

In the control method for an imaging system of the present disclosure, in response to the user performing the third operation on the interaction apparatus, a segment to be cut selected by the user from the recorded video is obtained, and the segment to be cut is deleted from the recorded video to obtain a trimmed video. By deleting part of the recorded video according to the segment to be cut selected by the user in the recorded video, all video frames in the trimmed video are videos needed by the user, reducing redundant segments, improving the video effect of the trimmed video, and also avoiding subsequent processing of the video by the user.

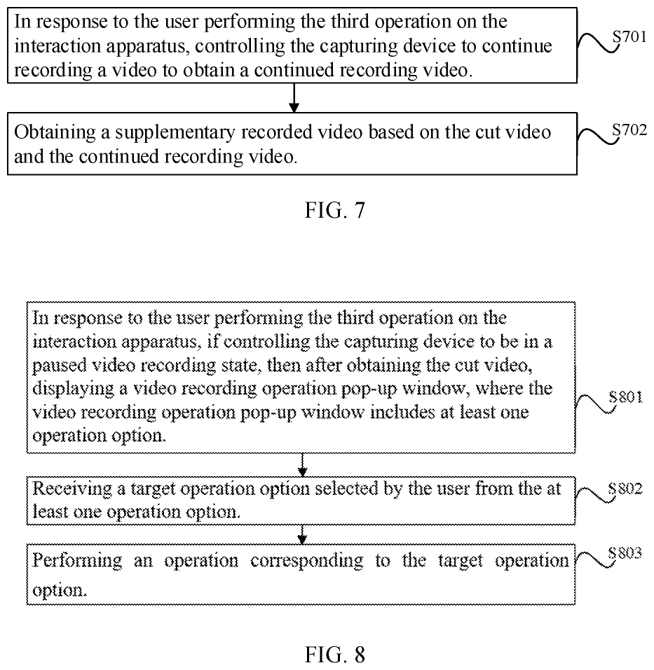

In an exemplary implementation, as shown in FIG. 7, the implementation includes the following operations.

S701: in response to the user performing the third operation on the interaction apparatus, controlling the capturing device to continue recording a video to obtain a continued recording video.

In response to the user performing the third operation on the interaction apparatus, the capturing device can be controlled to continue recording a video, and the video recorded after the user triggers the third operation is determined as the continued recording video.

S702: obtaining a supplementary recorded video based on the trimmed video and the continued recording video.

Then, the trimmed video and the continued recording video are spliced to obtain a supplementary recorded video; and the way to obtain the supplementary recorded video can be to splice the video frame corresponding to the end time of the trimmed video and the video frame corresponding to the start time of the continued recording video to obtain the supplementary recorded video. The supplementary recorded video can include the trimmed video and the continued recording video.

In some implementations, a preset splicing algorithm can also be used, where the trimmed video and the continued recording video are used as inputs to the splicing algorithm, and by running the splicing algorithm, the supplementary recorded video is obtained; and the supplementary recorded video can include at least one video frame from the trimmed video and at least one video frame from the continued recording video.

In the control method for an imaging system of the present disclosure, in response to the user performing the third operation on the interaction apparatus, the capturing device is controlled to continue recording a video to obtain a continued recording video, and then a supplementary recorded video is obtained based on the trimmed video and the continued recording video. In this method, during the process of cutting the recorded video by the user, the capturing device is still recording video, ensuring that the capturing device can record the video completely, improving the accuracy and effectiveness of video recording, and avoiding missing the recording of wonderful moments.

In an exemplary implementation, as shown in FIG. 8, the implementation includes the following operations.

S801: in response to the user performing the third operation on the interaction apparatus, if controlling the capturing device to be in a paused video recording state, then after obtaining the trimmed video, displaying a video recording operation pop-up window, where the video recording operation pop-up window includes at least one operation option.

After the user performs the third operation on the interaction apparatus, the capturing device can be controlled to be in a paused video recording state. After the trimmed video is obtained by cutting the recorded video, the screen of the capturing device can be controlled to display a video recording operation pop-up window, where the video recording operation pop-up window includes at least one operation option. For example, the video recording operation pop-up window can include options such as “continue recording,” “stop recording,” and “delete video.”

S802: receiving a target operation option selected by the user from the at least one operation option.

After the capturing device displaying at least one operation option, the user can select an operation option from the operation options, and the operation option selected by the user is used as the target operation option. The user can click the operation option, and the computer device responds to the operation option clicked by the user to determine the target operation option selected by the user from the operation options.

For example, if the user clicks the “continue recording” option, the “continue recording” option selected by the user from the operation options is received, and the target operation option is determined as the continue recording option; if the user clicks the “stop recording” option, the “stop recording” option selected by the user from the operation options is received, and the target operation option is determined as the stop recording option; and if the user clicks the “delete video” option, the “delete video” option selected by the user from the operation options is received, and the target operation option is determined as the delete video option.

S803: performing an operation corresponding to the target operation option.

After receiving the target operation option selected by the user, the computer device performs the operation corresponding to the target operation option according to the target operation option.

In an exemplary implementation, performing an operation corresponding to the target operation option includes: if the target operation option is a continue recording option, controlling the capturing device to continue video recording; if the target operation option is a stop recording option, terminating the video recording state of the capturing device and saving the trimmed video; and if the target operation option is a delete video option, deleting the trimmed video.

If the target operation option is a continue recording option, it means that video recording can continue, and the computer device can control the capturing device to continue video recording, continuing to record video after the trimmed video.

If the target operation option is a stop recording option, the computer device can terminate the video recording state of the capturing device and save the trimmed video to the video playback page of the capturing device.

If the target operation option is a delete video option, the computer device can delete the trimmed video. In some implementations, if the target operation option is a delete video option, the computer device can also delete the original recorded video of the trimmed video instead of deleting the trimmed video, or the computer device can delete both the trimmed video and the recorded video at the same time.

In the control method for an imaging system of the present disclosure, in response to the user performing the third operation on the interaction apparatus, if controlling the capturing device to be in a paused video recording state, then after obtaining the trimmed video, displaying a video recording operation pop-up window; the video recording operation pop-up window includes at least one operation option; then receiving a target operation option selected by the user from the at least one operation option; and performing an operation corresponding to the target operation option. In this method, the user can select an appropriate operation option in the video recording operation pop-up window according to actual needs. The capturing device receives the target operation option selected by the user from the operation options and performs the corresponding operation, providing greater flexibility.

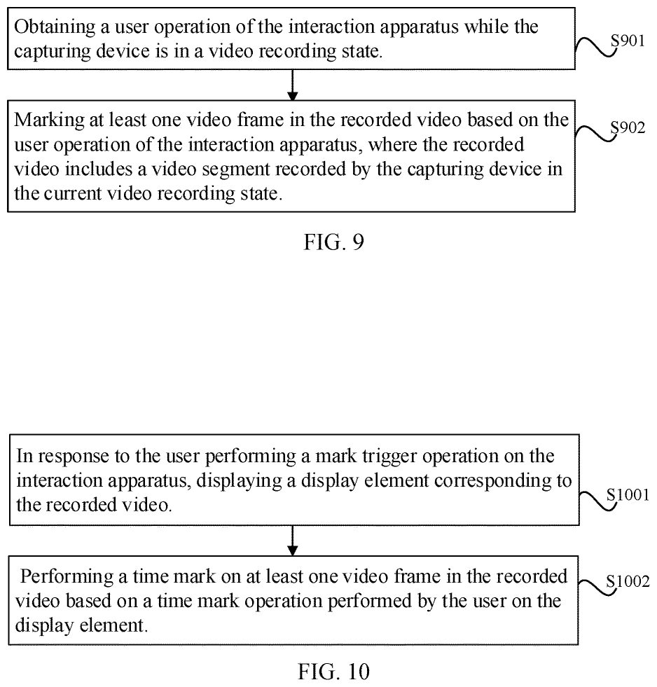

While the capturing device is in a video recording state, time marking can also be performed on the recorded video, so that specific video frames in the recorded video can be viewed later through the time marks, or local videos can be inserted or replaced in the recorded video. In an exemplary implementation, as shown in FIG. 9, processing a recorded video based on the user operation of the interaction apparatus includes the following operations.

S901: obtaining a user operation of the interaction apparatus while the capturing device is in a video recording state.

The user operation of the interaction apparatus can be the user performing a fourth operation on the interaction apparatus. In some implementations, it can also be the user performing a fourth operation on the recording element of the interaction apparatus.

The fourth operation can include a mark trigger operation; the user can perform a mark trigger operation on the interaction apparatus; and taking the shutter button as the interaction apparatus as an example, according to the preset operation form of the mark trigger operation, the user performs the mark trigger operation on the interaction apparatus, and the computer device responds to the mark trigger operation performed by the user on the interaction apparatus.

In some implementations, the recording element of the interaction apparatus can also be a mark trigger control on the screen of the capturing device, a mark trigger button on the capturing device, or a mark trigger button on the remote control device of the capturing device, etc.; and the user triggers the mark trigger operation by clicking the recording element of the interaction apparatus.

S902: marking at least one video frame in the recorded video based on the user operation of the interaction apparatus, where the recorded video includes a video segment recorded by the capturing device in the current video recording state.

Based on the mark trigger operation of the user on the interaction apparatus, the recorded video is obtained, and at least one video frame is marked in the recorded video.

In some implementations, the way to mark at least one video frame in the recorded video can be to mark at least one video frame in the recorded video according to a preset video marking model; and specifically, the recorded video is input into the video marking model, and the video marking model analyzes the recorded video to obtain at least one video frame in the recorded video, and then the at least one video frame is marked in the recorded video.

In some implementations, marking at least one video frame can also be that the user marks the video frame at the current time by operating the interaction apparatus.

In some implementations, multiple video frames can be marked in the recorded video.

In the control method for an imaging system of the present disclosure, while the capturing device is in a video recording state, a user operation of the interaction apparatus is obtained, and at least one video frame is marked in the recorded video based on the user operation of the interaction apparatus, where the recorded video includes a video segment recorded by the capturing device in the current video recording state. In this method, the user performs the corresponding operation on the interaction apparatus, and then at least one video frame in the recorded video is marked, which can provide a basis for subsequent video processing and editing, thereby improving the convenience and accuracy of video processing.

In an exemplary implementation, as shown in FIG. 10, marking at least one video frame in the recorded video based on the user operation of the interaction apparatus includes the following operations.

S1001, in response to the user performing a mark trigger operation on the interaction apparatus, displaying a display element corresponding to the recorded video.

After the user performs a mark trigger operation on the interaction apparatus, the computer device responds to the mark trigger operation performed by the user on the interaction apparatus and controls the capturing device to display the recorded video and the corresponding display element.

The display element corresponding to the recorded video can be the progress bar of the recorded video.

S1002, performing a time mark on at least one video frame in the recorded video based on a time mark operation performed by the user on the display element.

The user can perform a time mark operation on the display element of the recorded video, and the computer device responds to the time mark operation performed by the user on the display element to perform a time mark on at least one video frame in the recorded video.

The time mark operation can be triggered by the user operating the display element and the interaction apparatus; and taking the progress bar as the display element as an example, while the capturing device is in a video recording state, the user can view each video frame in the recorded video by dragging the progress bar. When the user wants to perform a time mark on a certain video frame, the progress bar can be dragged to the video frame to be time marked, and the user performs a time mark operation on the recording element of the interaction apparatus. The computer responds to the time mark operation and performs a time mark on the video frame to be time marked in the recorded video.

The recording element can be the shutter button, a time mark control on the screen of the capturing device, or a time mark button on the capturing device, etc. The way for the user to perform a time mark operation on the recording element of the interaction apparatus can be that the user triggers the recording element in a preset way; and the preset way can be clicking, pressing and holding for a preset duration, etc.

In the control method for an imaging system of the present disclosure, in response to the user performing a mark trigger operation on the interaction apparatus, a display element corresponding to the recorded video is displayed, and a time mark is performed on at least one video frame in the recorded video based on a time mark operation performed by the user on the display element. In this method, by performing a time mark on the video frame in the recorded video, subsequent video processing and editing can be facilitated; and by performing a time mark on the video frame in the recorded video through the display element of the recorded video, the efficiency of time marking is improved.

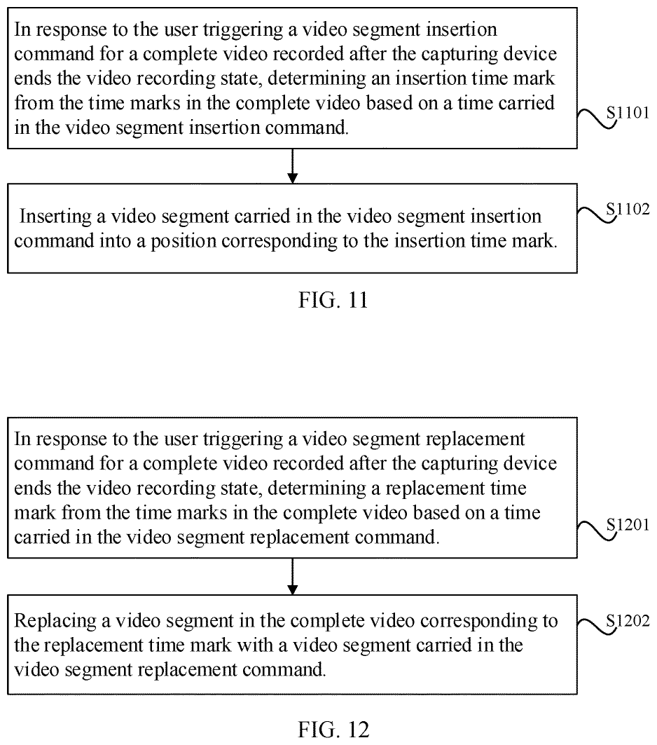

Through time marks, video segments can be inserted into the complete video, or video segments in the complete video can be replaced with video segments. The following implementation describes the way to insert a video segment through time marks. In an exemplary implementation, as shown in FIG. 11, the implementation includes the following operations.

S1101, in response to the user triggering a video segment insertion command for a complete video recorded after the capturing device ends the video recording state, determining an insertion time mark from the time marks in the complete video based on a time carried in the video segment insertion command.

After the capturing device ends the video recording state, the complete video recorded by the capturing device can be obtained, and the user can trigger a video segment insertion command in the complete video.

The user can send a video segment insertion command to the computer device, where the video segment insertion command can include a video identifier and a time. Therefore, the computer device can determine the complete video according to the video identifier in the video segment insertion command, and determine the insertion time mark from the time marks in the complete video based on the time in the video segment insertion command.

For example, if the time carried in the video segment insertion command is 5 seconds, the time corresponding to 5 seconds among the time marks in the complete video can be determined as the insertion time mark.

S1102, inserting a video segment carried in the video segment insertion command into a position corresponding to the insertion time mark.

The video segment insertion command also includes the video segment to be inserted. After the computer device determines the insertion time mark, the video segment carried in the video segment insertion command can be inserted into the position corresponding to the insertion time mark in the complete video.

For example, if the complete video includes a video of 0 -10 seconds, the insertion time mark is 5 seconds, and the video segment is a 4-second video segment, the 4-second video segment can be inserted at the 5-second position of the complete video, resulting in a 14-second video after insertion.

In the control method for an imaging system of the present disclosure, after the capturing device ends the video recording state, in response to the user triggering a video segment insertion command for a complete video recorded, an insertion time mark is determined from the time marks in the complete video based on a time carried in the video segment insertion command, and a video segment carried in the video segment insertion command is inserted into a position corresponding to the insertion time mark. In this method, the computer device can find the insertion position in the complete video according to the time carried in the video segment insertion command and insert the video segment at that position, thereby realizing the editing and modification of the complete video to meet the user's specific needs for the video.

The following implementation describes the way to replace a video segment in the complete video through time marks. In an exemplary implementation, as shown in FIG. 12, the implementation includes the following operations.

S1201, in response to the user triggering a video segment replacement command for a complete video recorded after the capturing device ends the video recording state, determining a replacement time mark from the time marks in the complete video based on a time carried in the video segment replacement command.

After the capturing device ends the video recording state, the complete video recorded by the capturing device can be obtained, and the user can trigger a video segment replacement command in the complete video.

The user can send a video segment replacement command to the computer device, where the video segment replacement command can include a video identifier and a time. Therefore, the computer device can determine the complete video according to the video identifier in the video segment insertion command, and determine the replacement time mark from the time marks in the complete video based on the time in the video segment replacement command.

For example, the time carried in the video segment replacement command can be multiple consecutive times. For example, the time carried in the video segment replacement command includes the consecutive times from 5 to 8 seconds, and the replacement time mark is 5-8 seconds.

S1202, replacing a video segment in the complete video corresponding to the replacement time mark with a video segment carried in the video segment replacement command.

The video segment replacement command also includes the video segment to be replaced. After the computer device determines the replacement time mark, the video segment in the complete video corresponding to the replacement time mark can be replaced with the video segment carried in the video segment replacement command to obtain the replaced complete video.

For example, if the complete video includes a video of 0 -10 seconds, the insertion time mark is 5-8 seconds, and the video segment carried in the video segment replacement command is a 4-second video segment, the video segment corresponding to 5-8 seconds in the complete video can be directly replaced with the 4-second video segment carried in the video segment replacement command, resulting in a 10-second video.

In the control method for an imaging system of the present disclosure, after the capturing device ends the video recording state, in response to the user triggering a video segment replacement command for a complete video recorded, a replacement time mark is determined from the time marks in the complete video based on a time carried in the video segment replacement command, and a video segment in the complete video corresponding to the replacement time mark is replaced with a video segment carried in the video segment replacement command. In this method, by responding to the video segment replacement command, the replacement position is found according to the replacement time mark, and the video segment in the command is replaced with the corresponding video segment in the complete video, which can realize the replacement and modification of the complete video, meet the user's personalized needs for the video, and provide a better video viewing experience.

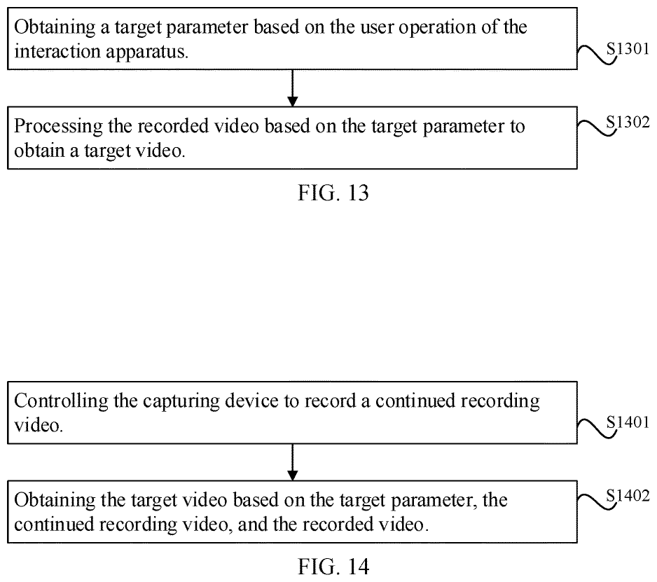

In an exemplary implementation, as shown in FIG. 13, processing a recorded video based on the user operation of the interaction apparatus includes the following operations.

S1301, obtaining a target parameter based on the user operation of the interaction apparatus.

The interaction apparatus can be a button on the capturing device, a touch screen on the recording interface of the capturing device, or a remote control device corresponding to the capturing device.

The user performs a preset fifth operation on the interaction apparatus, and the computer device responds to the fifth operation to obtain the target parameter.

The target parameter can be generated after the user performs the fifth operation on the interaction apparatus, or it can be a preset parameter stored in the memory of the capturing device. After the user performs the fifth operation on the interaction apparatus, the computer device obtains the target parameter from the memory.

Taking the parameter acquisition button on the capturing device as the interaction apparatus as an example, while the capturing device is in a video recording state, the user clicks the parameter acquisition button on the capturing device, and the computer device responds to the user's clicking on the parameter acquisition button to obtain the target parameter.

In some implementations, obtaining a target parameter based on the user operation of the interaction apparatus can also include: obtaining a target parameter based on the user operation of a recording element of the interaction apparatus.

Specifically, the recording element can be the progress bar of the recorded video in the recording interface of the capturing device. Taking the position as the target parameter as an example, while the capturing device is in a recording state, the user can drag the progress bar of the recorded video according to the user's needs and trigger at a certain position in the recorded video. The computer device responds to the user's triggering at the position to obtain the position and determines the position as the target parameter.

Triggering at a certain position in the recorded video can include: there is a position trigger button on the capturing device or a position trigger button on the recording interface. After the user drags the progress bar of the recorded video to a certain position, the user clicks the position trigger button.

S1302, processing the recorded video based on the target parameter to obtain a target video.

The target video can be the video obtained after processing the recorded video, and the target video is the video finally needed by the user.

The target parameter can include at least one position, and the way to process the recorded video can include deleting the video frames corresponding to each position in the recorded video to obtain the target video.

The target parameter can include two positions, and the way to process the recorded video can also include swapping the video frames corresponding to the two positions in the recorded video, and determining the recorded video after swapping as the target video.

In the control method for an imaging system of the present disclosure, a target parameter is obtained based on the user operation of the interaction apparatus, and the recorded video is processed based on the target parameter to obtain a target video. In this method, the recorded video is directly processed based on the target parameter while the capturing device is in a recording state, improving the efficiency of video processing.

In an exemplary implementation, as shown in FIG. 14, processing the recorded video based on the target parameter to obtain the target video includes the following operations.

S1401, controlling the capturing device to record a continued recording video.

After obtaining the target parameter, the computer device can control the capturing device to record a continued recording video.

While the capturing device is in a video recording state, after the user operates the interaction apparatus, the computer device controls the capturing device to pause recording and obtain the target parameter. After obtaining the target parameter, the capturing device is controlled to continue recording, and the video recorded after continuing recording is used as the continued recording video.

In some implementations, while the capturing device is in a video recording state, after the user operates the interaction apparatus, the computer device obtains the target parameter, and the video recorded after the user operates the interaction apparatus is used as the continued recording video, and the video recorded before the user operates the interaction apparatus is used as the recorded video.

S1402, obtaining the target video based on the target parameter, the continued recording video, and the recorded video.

The target parameter includes an insertion position selected by the user from the recorded video. The interaction apparatus can include a video insertion control button. The user can drag the progress bar of the recorded video to a certain position in the recorded video and trigger the video insertion control button. The computer device responds to the video insertion control button triggered by the user and determines the position of the progress bar of the recorded video when the video insertion control button is triggered as the insertion position, that is, the insertion position selected by the user from the recorded video, and determines the insertion position as the target parameter.

In an exemplary implementation, obtaining the target video based on the target parameter, the continued recording video, and the recorded video includes: inserting the continued recording video into the recorded video based on the insertion position to obtain the target video.

Based on the insertion position, the recorded video is divided into a first segment and a second segment. The end position of the video in the first segment is the insertion position, and the start position of the video in the second segment is the insertion position. Therefore, the end position of the video in the first segment is spliced with the start position of the continued recording video, and the end position of the continued recording video is spliced with the start position of the video in the second segment, that is, the first segment, the continued recording video, and the second segment are spliced in sequence to obtain the target video.

In an exemplary implementation, the implementation further includes: deleting a video segment in the recorded video after the insertion position.

Specifically, according to the insertion position of the recorded video in the target parameter, the video segment in the recorded video before the insertion position is spliced with the continued recording video, and the video segment in the recorded video after the insertion position is deleted.

In the control method for an imaging system of the present disclosure, the capturing device is controlled to record a continued recording video, and the target video is obtained based on the target parameter, the continued recording video, and the recorded video. In this method, the recorded video is processed based on the target parameter and the continued recording video, improving the processing speed of the recorded video.

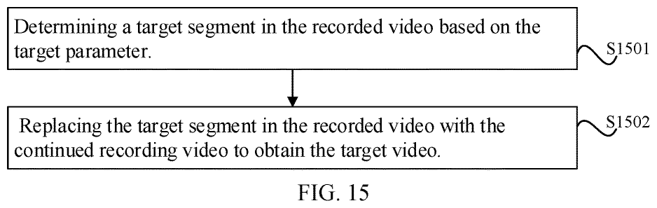

In an exemplary implementation, as shown in FIG. 15, obtaining the target video based on the target parameter, the continued recording video, and the recorded video includes the following operations.

S1501, determining a target segment in the recorded video based on the target parameter.

In an exemplary implementation, the target parameter includes a starting position selected by the user from the recorded video and a continued recording video duration of the continued recording video.

The interaction apparatus can include a first video replacement control button. The user can drag the progress bar of the recorded video to a certain position in the recorded video and trigger the first video replacement control button. The computer device responds to the first video replacement control button triggered by the user and determines the position of the progress bar of the recorded video when the first video replacement control button is triggered as the starting position, that is, the starting position selected by the user from the recorded video.

The continued recording video duration can be a preset duration of the continued recording video to be recorded, and the computer device can also record the continued recording video according to the continued recording video duration.

Therefore, when the target parameter includes a starting position selected by the user from the recorded video and a continued recording video duration of the continued recording video, determining a target segment in the recorded video based on the target parameter includes: determining the target segment in the recorded video based on the starting position and the continued recording video duration, where the starting position and a starting position of the target segment are at the same position, and a duration of the target segment is the same as the continued recording video duration.

The video segment in the recorded video from the starting position to the time of the continued recording video duration is determined as the target segment. For example, if the recorded video is 0 -10 seconds, the starting position is the 3rd second, and the continued recording video duration is 5 seconds, the segment from the 3rd to the 8th second in the recorded video can be determined as the target segment.

In another exemplary implementation, the target parameter includes a starting position selected by the user from the recorded video and a target duration.

The interaction apparatus can include a second video replacement control button. The user can drag the progress bar of the recorded video to a certain position in the recorded video and trigger the second video replacement control button. The computer device responds to the second video replacement control button triggered by the user and determines the position of the progress bar of the recorded video when the second video replacement control button is triggered as the starting position, that is, the starting position selected by the user from the recorded video.

The target duration is a preset duration that can replace the video segment in the recorded video. In some implementations, the duration of the continued recording video may be longer than the target duration.

Therefore, when the target parameter includes a starting position selected by the user from the recorded video and a target duration, determining a target segment in the recorded video based on the target parameter includes: determining the target segment in the recorded video based on the starting position and the target duration, where the starting position and a starting position of the target segment are at the same position, and a duration of the target segment is the same as the target duration.

The video segment in the recorded video from the starting position to the time of the target duration is determined as the target segment. For example, if the recorded video is 0 -10 seconds, the starting position is the 3rd second, and the target duration is 5 seconds, the segment from the 3rd to the 8th second in the recorded video can be determined as the target segment.

In another exemplary implementation, the target parameter includes a starting position and an ending position selected by the user from the recorded video.

The interaction apparatus can include a third video replacement control button. The user can drag the progress bar of the recorded video to a first position and a second position in the recorded video and trigger the third video replacement control button, respectively. The computer device responds to the third video replacement control button triggered by the user and determines the first position and the second position of the progress bar of the recorded video when the third video replacement control button is triggered as the starting position and the ending position, that is, the starting position and the ending position selected by the user from the recorded video.

For example, if the time corresponding to the first position is before the time corresponding to the second position, the first position is determined as the starting position and the second position is determined as the ending position; and if the time corresponding to the second position is before the time corresponding to the first position, the second position is determined as the starting position and the first position is determined as the ending position.

Therefore, when the target parameter includes a starting position and an ending position selected by the user from the recorded video, determining a target segment in the recorded video based on the target parameter includes: determining a video segment between the starting position and the ending position in the recorded video as the target segment.

S1502, replacing the target segment in the recorded video with the continued recording video to obtain the target video.

The target segment in the recorded video is replaced with the continued recording video to obtain the target video.

If the duration of the continued recording video is longer than the duration of the target segment, the video segment in the continued recording video corresponding to the duration of the target segment is replaced with the target segment in the recorded video in chronological order, and the replaced video is determined as the target video; for example, if the duration of the target segment is 5 seconds and the segment of the continued recording video is 8 seconds, the first 5 seconds of the continued recording video is used to replace the target segment in the recorded video.

If the duration of the continued recording video is equal to the duration of the target segment, the target segment in the recorded video can be directly replaced with the continued recording video to obtain the target video.

In this implementation, when the user is not satisfied with a certain segment of the recorded video, the continued recording operation can be performed to re-record the continued recording video and replace the unsatisfactory segment.

If the duration of the continued recording video is less than the duration of the target segment, the target segment in the recorded video can be directly replaced with the continued recording video to obtain the target video; or the continued recording video can be used to replace the video segment in the recorded video corresponding to the duration of the continued recording video in chronological order.

For example, if the duration of the target segment is 8 seconds and the segment of the continued recording video is 5 seconds, the 8-second target segment in the recorded video is replaced with a 5-second target segment; and if the duration of the target segment is 8 seconds and the segment of the continued recording video is 5 seconds, the first 5 seconds of the continued recording video is used to replace the first 5 seconds of the target segment.

In the present disclosure, based on the target parameter, a target segment in the recorded video is determined, and the target segment in the recorded video is replaced with the continued recording video to obtain the target video. In this method, the video segment in the recorded video is directly replaced while the capturing device is in a recording state, reducing the steps of processing the video on the video playback page and improving the speed of video processing.

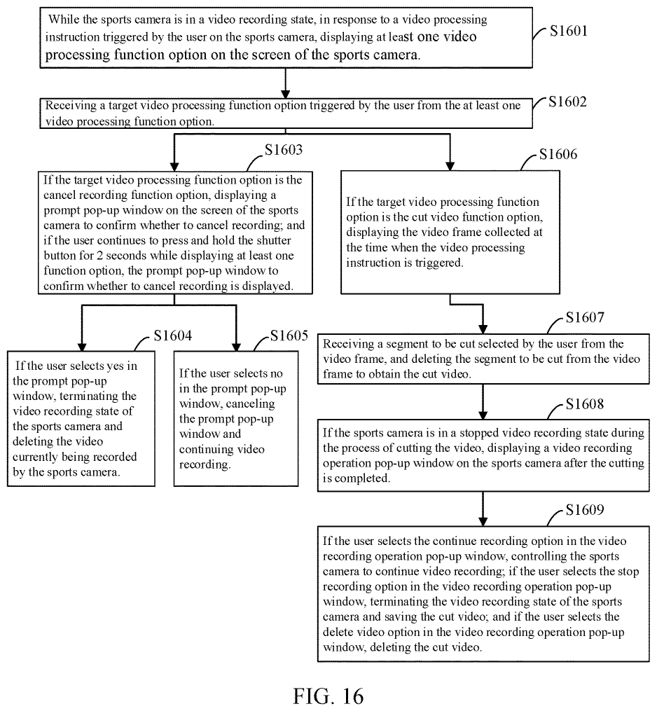

In an exemplary implementation, the present disclosure also provides a control method for an imaging system, taking the capturing device as a sports camera as an example, as shown in FIG. 16, the implementation includes the following operations.

S1601, while the sports camera is in a video recording state, in response to a video processing instruction triggered by the user on the sports camera, displaying at least one video processing function option on the screen of the sports camera.

The video processing instruction can be triggered by the user pressing and holding the shutter button of the sports camera for 1 second, and the video processing function options include “cancel recording function option” and “trimmed video function option.”

S1602, receiving a target video processing function option triggered by the user from the at least one video processing function option.

S1603, if the target video processing function option is the cancel recording function option, displaying a prompt pop-up window on the screen of the sports camera to confirm whether to cancel recording; and if the user continues to press and hold the shutter button for 2 seconds while displaying at least one function option, the prompt pop-up window to confirm whether to cancel recording is displayed.

S1604, if the user selects yes in the prompt pop-up window, terminating the video recording state of the sports camera and deleting the video currently being recorded by the sports camera.

S1605, if the user selects no in the prompt pop-up window, canceling the prompt pop-up window and continuing video recording.

S1606, if the target video processing function option is the trimmed video function option, displaying the video frame collected at the time when the video processing instruction is triggered.

S1607, receiving a segment to be cut selected by the user from the video frame, and deleting the segment to be cut from the video frame to obtain the trimmed video.

S1608, if the sports camera is in a stopped video recording state during the process of cutting the video, displaying a video recording operation pop-up window on the sports camera after the cutting is completed.

The video recording operation pop-up window includes options such as continue recording, delete video, and stop recording.

S1609, if the user selects the continue recording option in the video recording operation pop-up window, controlling the sports camera to continue video recording; if the user selects the stop recording option in the video recording operation pop-up window, terminating the video recording state of the sports camera and saving the trimmed video; and if the user selects the delete video option in the video recording operation pop-up window, deleting the trimmed video.

While the capturing device is in a video recording state, the video being recorded can include a progress bar. By dragging the progress bar, previously recorded video segments can be viewed, and video cutting can also be performed through the progress bar. Furthermore, during the recording process, time points can be marked through the progress bar. When the user wants to insert a video or replace a new video segment at a certain time point, the time point can be marked, and after the recording is completed, the time point can be found, and the video can be inserted or replaced at that time point.

In addition, while the capturing device is in a recording state, the recording screen can also include fast forward and rewind buttons, and the video can be viewed by fast forward and rewind buttons. In some implementations, the fast forward and rewind functions can also be set on external buttons of the capturing device.

It should be understood that although the operations in the flowcharts of the above implementations are shown sequentially according to the arrows, these operations are not necessarily performed in the order indicated by the arrows. Unless explicitly stated herein, the execution of these operations is not strictly limited in order, and these operations can be performed in other orders. Moreover, at least some of the operations in the flowcharts of the above implementations can include multiple operations or multiple stages, and these operations or stages are not necessarily completed at the same time, but can be performed at different times. The execution order of these operations or stages is not necessarily sequential, but can be performed alternately or in turn with at least part of other operations or operations in other stages.

Based on the same concept, some implementations of the present disclosure also provide a control apparatus for an imaging system for implementing the control method for an imaging system described above. The solution for solving the problem provided by the apparatus is similar to the solution described in the method above. Therefore, the specific limitations in one or more implementations of the control apparatus for an imaging system provided below can refer to the limitations of the control method for an imaging system described above and will not be repeated here.

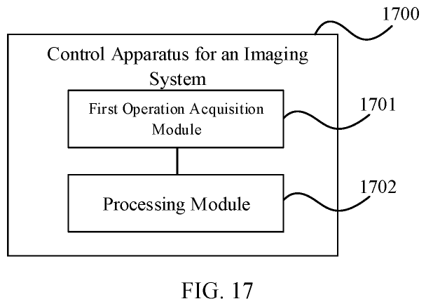

In an exemplary implementation, as shown in FIG. 17, an imaging system and its control apparatus 1700 are provided, including: a first operation acquisition module 1701 and a processing module 1702, where:
the first operation acquisition module 1701 is configured to obtain a user operation of the interaction apparatus while the capturing device is in a video recording state; and
the processing module 1702 is configured to process a recorded video based on the user operation of the interaction apparatus; and the recorded video includes a video segment recorded by the capturing device in the current video recording state.

In one implementation, the processing module 1702 includes:
a first deletion unit, configured to delete at least one video frame from the recorded video based on the user operation of the interaction apparatus.

In one implementation, the first deletion unit includes:
a first deletion subunit, configured to delete the recorded video in response to the user performing a first operation on the interaction apparatus.

In one implementation, the apparatus 1700 further includes:
a first control module, configured to control the capturing device to exit the video recording state.

In one implementation, the first operation acquisition module 1701 includes:
a first acquisition unit, configured to obtain a user operation of a recording element of the interaction apparatus while the capturing device is in a video recording state.

In one implementation, the processing module 1702 includes:
a second deletion unit, configured to delete the recorded video in response to the user performing a first operation on the recording element of the interaction apparatus; and
a saving unit, configured to save the recorded video in response to the user performing a second operation on the recording element of the interaction apparatus; the first operation and the second operation are different.

In one implementation, the first operation includes: triggering the recording element of the interaction apparatus for a first preset duration; and
the second operation includes: triggering the recording element of the interaction apparatus for a second preset duration, where the first preset duration is longer than the second preset duration.

In one implementation, the first operation includes: triggering the recording element, and re-triggering the recording element for a fourth preset duration within a third preset duration after the triggering of the recording element.

In one implementation, the processing module 1702 includes:
a second acquisition unit, configured to obtain a segment to be cut selected by the user from the recorded video in response to the user performing a third operation on the interaction apparatus; and
a third acquisition unit, configured to delete the segment to be cut from the recorded video and obtain a trimmed video.

In one implementation, the second acquisition unit includes:
a display subunit, configured to display a display element corresponding to the recorded video in response to the user performing a cut trigger operation on the interaction apparatus; and
a first determination subunit, configured to determine the segment to be cut based on a segment selection operation performed by the user on the display element.

In one implementation, the third acquisition unit includes:
a first acquisition subunit, configured to obtain a first video segment before a start time of the segment to be cut from the recorded video;
a second acquisition subunit, configured to obtain a second video segment after an end time of the segment to be cut from the recorded video; and
a third acquisition subunit, configured to splice the first video segment and the second video segment to obtain the trimmed video.

In one implementation, the apparatus 1700 further includes:
a second control module, configured to control the capturing device to continue recording a video to obtain a continued recording video in response to the user performing the third operation on the interaction apparatus; and
an obtaining module, configured to obtain a supplementary recorded video based on the trimmed video and the continued recording video.

In one implementation, the apparatus 1700 further includes:
a display module, configured to display a video recording operation pop-up window after obtaining the trimmed video if the capturing device is controlled to be in a paused video recording state in response to the user performing the third operation on the interaction apparatus, where the video recording operation pop-up window includes at least one operation option;
a receiving module, configured to receive a target operation option selected by the user from the operation options; and
an execution module, configured to perform an operation corresponding to the target operation option.

In one implementation, the execution module includes:
a first determination unit, configured to control the capturing device to continue video recording if the target operation option is a continue recording option;
a second determination unit, configured to terminate the video recording state of the capturing device and save the trimmed video if the target operation option is a stop recording option; and
a third determination unit, configured to delete the trimmed video if the target operation option is a delete video option.

In one implementation, the processing module 1702 includes:
a second operation acquisition module, configured to obtain a user operation of the interaction apparatus while the capturing device is in a video recording state; and a video marking module, configured to mark at least one video frame in the recorded video based on the user operation of the interaction apparatus; the recorded video includes a video segment recorded by the capturing device in the current video recording state.

In one implementation, the video marking module includes:
a display unit, configured to display a display element corresponding to the recorded video in response to the user performing a mark trigger operation on the interaction apparatus; and
a marking unit, configured to perform a time mark on at least one video frame in the recorded video based on a time mark operation performed by the user on the display element.

In one implementation, the apparatus 1700 further includes:
a first determination module, configured to determine an insertion time mark from the time marks in the complete video based on a time carried in the video segment insertion command in response to the user triggering a video segment insertion command for a complete video recorded after the capturing device ends the video recording state; and
an insertion module, configured to insert a video segment carried in the video segment insertion command into a position corresponding to the insertion time mark.

In one implementation, the apparatus 1700 further includes:
a second determination module, configured to determine a replacement time mark from the time marks in the complete video based on a time carried in the video segment replacement command in response to the user triggering a video segment replacement command for a complete video recorded after the capturing device ends the video recording state; and
a replacement module, configured to replace a video segment in the complete video corresponding to the replacement time mark with a video segment carried in the video segment replacement command.

In one implementation, the processing module 1702 includes:
a fourth acquisition unit, configured to obtain a target parameter based on the user operation of the interaction apparatus; and
an obtaining unit, configured to process the recorded video based on the target parameter to obtain a target video.

In one implementation, the obtaining unit includes:
a control subunit, configured to control the capturing device to record a continued recording video; and
a first obtaining subunit, configured to obtain the target video based on the target parameter, the continued recording video, and the recorded video.

In one implementation, the target parameter includes an insertion position selected by the user from the recorded video, and the first obtaining subunit includes:
a second obtaining subunit, configured to insert the continued recording video into the recorded video based on the insertion position to obtain the target video.

In one implementation, the apparatus 1700 further includes:
a deletion module, configured to delete a video segment in the recorded video after the insertion position.

In one implementation, the first obtaining subunit includes:
a second determination subunit, configured to determine a target segment in the recorded video based on the target parameter; and
a third obtaining subunit, configured to replace the target segment in the recorded video with the continued recording video to obtain the target video.

In one implementation, the target parameter includes a starting position selected by the user from the recorded video and a continued recording video duration of the continued recording video; and the second determination subunit includes:
a third determination subunit, configured to determine the target segment in the recorded video based on the starting position and the continued recording video duration, where the starting position and a starting position of the target segment are at the same position, and a duration of the target segment is the same as the continued recording video duration.

In one implementation, the target parameter includes a starting position selected by the user from the recorded video and a target duration, where the second determination subunit includes:
a fourth determination subunit, configured to determine the target segment in the recorded video based on the starting position and the target duration, where the starting position and a starting position of the target segment are at the same position, and a duration of the target segment is the same as the target duration.

In one implementation, the target parameter includes a starting position and an ending position selected by the user from the recorded video; the second determination subunit includes:
a fifth determination subunit, configured to determine a video segment between the starting position and the ending position in the recorded video as the target segment.

Each module in the control apparatus for an imaging system described above can be implemented entirely or partially by software, hardware, or a combination thereof. The above modules can be embedded in or independent of the processor of the computer device in hardware form, or can be stored in the memory of the computer device in software form for the processor to call and execute the operations corresponding to each module described above.

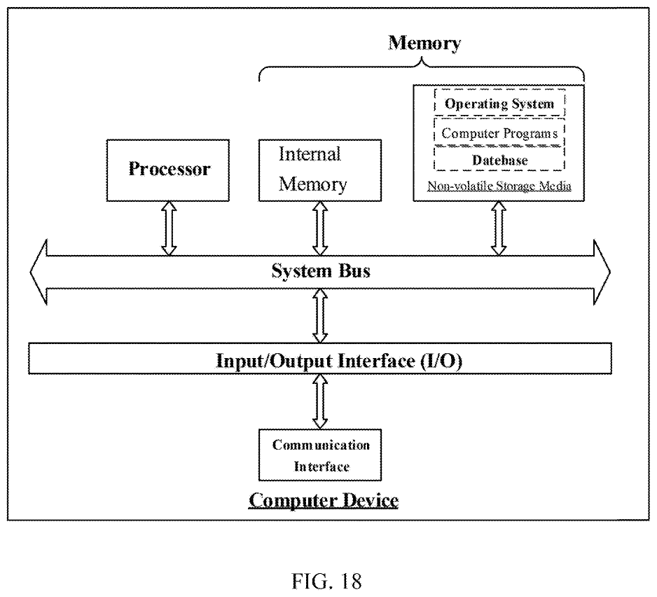

In an exemplary implementation, a computer device is provided, which can be a server, and its internal structure is shown in FIG. 18. For example, the computer device can be part of the capturing device and coupled to the camera of the capturing device. The computer device includes a processor, a memory, an input/output interface (I/O), and a communication interface. The processor, memory, and input/output interface are connected through a system bus, and the communication interface is coupled to the system bus through the input/output interface. The processor of the computer device is configured to provide computing and control capabilities. The memory of the computer device includes non-volatile storage media and internal memory. The non-volatile storage media stores the operating system, computer programs, and databases. The internal memory provides an environment for running the operating system and computer programs in the non-volatile storage media. The database of the computer device is configured to store video processing data. The input/output interface of the computer device is configured for exchanging information between the processor and external devices. The communication interface of the computer device is configured for communication with external terminals through a network. When the computer program is executed by the processor, it implements a control method for an imaging system.

Those skilled in the art can understand that the structure shown in FIG. 18 is only a block diagram of the relevant part of the present disclosure and does not constitute a limitation on the computer device to which the present disclosure is applied. The specific computer device can include more or fewer components than those shown in the figure, or combine some components, or have different component arrangements.

In an exemplary implementation, an imaging system is further provided, including an imaging device, a memory, and a processor. The memory stores a computer program, and the processor is coupled to the imaging device and implements the steps of the above method implementations when executing the computer program.

The steps implemented by the processor in some implementations of the present disclosure are similar in principle and technical effect to the control method for an imaging system described above and will not be repeated here.

In an exemplary implementation, a computer device is further provided, including a memory and a processor. The memory stores a computer program, and the processor implements the steps of the above method implementations when executing the computer program.

The steps implemented by the processor in some implementations of the present disclosure are similar in principle and technical effect to the control method for an imaging system described above and will not be repeated here.

In an exemplary implementation, a computer-readable storage medium is further provided, on which a computer program is stored. When the computer program is executed by a processor, it implements the steps of the above method implementations.

The steps implemented by the computer program when executed by the processor in some implementations of the present disclosure are similar in principle and technical effect to the control method for an imaging system described above and will not be repeated here.

In an exemplary implementation, a computer program product is further provided, including a computer program. When the computer program is executed by a processor, it implements the steps of the above method implementations.

The steps implemented by the computer program when executed by the processor in some implementations of the present disclosure are similar in principle and technical effect to the control method for an imaging system described above and will not be repeated here.

It should be noted that the data involved in the present disclosure (including but not limited to data for analysis, storage, display, etc.) are all information and data authorized by the user or fully authorized by all parties, and the collection, use, and processing of relevant data need to comply with relevant regulations.

Those skilled in the art can understand that all or part of the operations in the method implementations described above can be completed by instructing related hardware through a computer program. The computer program can be stored in a non-volatile computer-readable storage medium, and when executed, can include the processes of the implementation method described above. Any reference to memory, database, or other media used in some implementations of the present disclosure can include at least one of non-volatile and volatile memory. Non-volatile memory can include Read-Only Memory (ROM), tape, floppy disk, flash memory, optical storage, high-density embedded non-volatile memory, resistive random access memory (ReRAM), Magnetoresistive random access memory (MRAM), ferroelectric random access memory (FRAM), phase change memory (PCM), graphene memory, etc. Volatile memory can include Random Access Memory (RAM) or external high-speed cache, etc. By way of illustration and not limitation, RAM can be in various forms, such as Static Random Access Memory (SRAM) or Dynamic Random Access Memory (DRAM), etc. The database involved in some implementations of the present disclosure can include at least one of relational and non-relational databases. Non-relational databases can include blockchain-based distributed databases, etc., without limitation. The processor involved in some implementations of the present disclosure can be a general-purpose processor, central processing unit, graphics processor, digital signal processor, programmable logic device, quantum computing-based data processing logic, etc., without limitation.

The technical features of the above implementations can be combined arbitrarily. For the sake of brevity, not all possible combinations of the technical features in the above implementations are described, but as long as there is no contradiction in the combination of these technical features, they should be considered within the scope described in this specification.

The above implementations only express several implementations of the present disclosure, and their descriptions are relatively specific and detailed, but should not be understood as limiting the scope of the present disclosure. It should be noted that for those skilled in the art, several modifications and improvements can be made without departing from the concept of the present disclosure, and these all fall within the protection scope of the present disclosure. Therefore, the protection scope of the present disclosure should be subject to the appended claims.

What is claimed is:

1. A method for controlling an imaging system, comprising:
obtaining a user operation of an interaction apparatus while a capturing device is in a video recording state;
processing a recorded video based on the user operation of the interaction apparatus, wherein the recorded video comprises a video segment recorded by the capturing device in a current video recording state;
in response to a first operation being performed on a recording element of the interaction apparatus, deleting the recorded video, the first operation comprising triggering the recording element of the interaction apparatus for a first preset duration; and
in response to a second operation being performed on the recording element of the interaction apparatus, saving the recorded video, the second operation comprising triggering the recording element of the interaction apparatus for a second preset duration.

2. The method according to claim 1, wherein the first operation is the user's pressing and holding a shutter button for the first preset duration.

3. The method according to claim 1, wherein after deleting the recorded video, the method further comprises:
controlling the capturing device to exit the video recording state.

4. The method according to claim 1, wherein obtaining the user operation of the interaction apparatus while the capturing device is in the video recording state comprises:
obtaining the user operation of the recording element of the interaction apparatus while the capturing device is in the video recording state.

5. The method according to claim 1, wherein the first operation comprises:
triggering the recording element, and re-triggering the recording element for a fourth preset duration within a third preset duration after the triggering of the recording element.

6. The method according to claim 1, further comprising:
in response to a third operation being performed on the interaction apparatus, obtaining a segment to be cut selected from the recorded video; and
deleting the segment to be cut from the recorded video and obtaining a trimmed video.

7. The method according to claim 6, wherein in response to the third operation being performed on the interaction apparatus, obtaining the segment to be cut selected from the recorded video comprises:
in response to a cut trigger operation being performed on the interaction apparatus, displaying a display element corresponding to the recorded video; and
determining the segment to be cut based on a segment selection operation performed on the display element.

8. The method according to claim 6, further comprising:
in response to the third operation being performed on the interaction apparatus, when the capturing device is controlled to be in a paused video recording state, displaying a video recording operation pop-up window after obtaining the trimmed video, wherein the video recording operation pop-up window comprises at least one operation option;
receiving a target operation option selected from the at least one operation option; and
performing an operation corresponding to the target operation option.

9. The method according to claim 6, wherein deleting the segment to be cut from the recorded video and obtaining the trimmed video comprises:
obtaining a first video segment before a start time of the segment to be cut from the recorded video;
obtaining a second video segment after an end time of the segment to be cut from the recorded video; and
splicing the first video segment and the second video segment to obtain the trimmed video.

10. The method according to claim 7, further comprising:
in response to the third operation being performed on the interaction apparatus, controlling the capturing device to continue recording a video to obtain a continued recording video; and
obtaining a supplementary recorded video based on the trimmed video and the continued recording video.

11. The method according to claim 7, further comprising:
in response to the third operation being performed on the interaction apparatus, if controlling the capturing device to be in a paused video recording state, then after obtaining the cut video, displaying a video recording operation pop-up window, wherein the video recording operation pop-up window comprises at least one operation option;
receiving a target operation option selected by the user from the at least one operation option; and
performing an operation corresponding to the target operation option.

12. The method according to claim 1, wherein processing the recorded video based on the user operation of the interaction apparatus comprises:
marking at least one video frame in the recorded video based on the user operation of the interaction apparatus.

13. The method according to claim 12, wherein marking the at least one video frame in the recorded video based on the user operation of the interaction apparatus comprises:
in response to a mark trigger operation being performed on the interaction apparatus, displaying a display element corresponding to the recorded video; and
performing a time mark on the at least one video frame in the recorded video based on a time mark operation performed on the display element.

14. The method according to claim 12, further comprising:
in response to a video segment insertion command being triggered for a complete video recorded after the capturing device ends the video recording state, determining an insertion time mark from time marks in the complete video based on a time carried in the video segment insertion command; and
inserting a video segment carried in the video segment insertion command into a position corresponding to the insertion time mark.

15. The method according to claim 1, wherein processing the recorded video based on the user operation of the interaction apparatus comprises:
obtaining a target parameter based on the user operation of the interaction apparatus; and
processing the recorded video based on the target parameter to obtain a target video.

16. The method according to claim 15, wherein processing the recorded video based on the target parameter to obtain the target video comprises:
controlling the capturing device to record a continued recording video; and
obtaining the target video based on the target parameter, the continued recording video, and the recorded video.

17. The method according to claim 16, wherein the target parameter comprises an insertion position selected from the recorded video, and obtaining the target video based on the target parameter, the continued recording video, and the recorded video comprises:
inserting the continued recording video into the recorded video based on the insertion position to obtain the target video.

18. The method according to claim 17, further comprising:
deleting a video segment in the recorded video after the insertion position.

19. The method according to claim 16, wherein obtaining the target video based on the target parameter, the continued recording video, and the recorded video comprises:
determining a target segment in the recorded video based on the target parameter; and
replacing the target segment in the recorded video with the continued recording video to obtain the target video.

20. An imaging system, comprising a capturing device, a memory, and a processor, wherein the memory stores a computer program, and the processor is coupled to the capturing device and, when executing the computer program, configured to:
obtain a user operation of an interaction apparatus while the capturing device is in a video recording state; and
process a recorded video based on the user operation of the interaction apparatus, wherein the recorded video comprises a video segment recorded by the capturing device in a current video recording state.
